(19) United States
(12) Patent Application Publication
(10) Pub. No.: US 2013/0303151 A1
(43) Pub. Date: Nov. 14, 2013

(54) RINGTONE PUSH SYSTEM AND METHOD

(71) Applicant: Terry Johnson, Carlsbad, CA (US)

(72) Inventor: Terry Johnson, Carlsbad, CA (US)

(21) Appl. No.: 13/894,356

(22) Filed: May 14, 2013

Related U.S. Application Data
(60) Provisional application No. 61/646,875, filed on May 14, 2012.

(51) Int. Cl. H04W 4/00

(52) U.S. Cl. CPC H04W 4/003
USPC 455/419

(57) ABSTRACT

A system and method enabling playing by a called device of a media file designated by a calling device. A ringtone setup request is received by a media server. The ringtone setup request includes at least an identifier of the called device and a designation of a media file to be played by the called device as a ringtone when a calling device makes a call to the called device. The ringtone setup request is sent to the called device for an acknowledgement. Upon receipt of the acknowledgement, the media is assigned to the calling device in the called device, and the media can either be downloaded or stored on the network for being played with the calling device makes a call to the called device.

### CROSS-REFERENCE TO RELATED APPLICATIONS

This application claims the benefit of priority under 35 U.S.C. §119(e) of U.S. Provisional Patent Application Serial No. 61/646,875, filed May 14, 2012, entitled “Ringtone Push System and Method,” the disclosure of which is incorporated by reference herein.

### TECHNICAL FIELD

The subject matter described herein relates to mobile communications, and more particularly to a system and method for enabling a calling party to select media content to be played by a mobile device associated with a recipient of a call from the calling party.

### BACKGROUND

A ringtone is a sound made by a telephone to indicate an incoming call or text message. Conventionally, a ringtone is not so much a tone, but a media content file that has been customized for playing on modern mobile devices such as cell phones and smartphones. The media content file can include, without limitation, an audio file of music or other tunes, a voice file, a video file, or combinations thereof.

Typically, a user of a mobile device accesses a collection of available ringtones, selects a ringtone for any of a number of callers, and downloads the media content file to their mobile device. Whenever a call or text message is received, and based on configurations by the recipient user of the mobile device, the mobile device will play the media content file. Often, ringtones represent a part of a song or music, and derive popularity by enabling a mobile device user to augment their personality and mobile device personalization by choosing their own ringtone. In essence, today a recipient of a call or message controls and customizes the ringtones on their device for the calls and text messages they receive.

### SUMMARY

This document provides a system and method in which a caller controls the ringtone of a recipient and to be played by a mobile device of the recipient. The system and method enables a mobile device user to select media content, designate the selected media content to one or more recipients, and then have the one or more recipients play the selected media content when the mobile device user contacts the one or more recipients via a communications network.

In one aspect, a method includes receiving a ringtone setup request by a media server, the ringtone setup request including at least an identifier of a called device and a designation of a media file to be played by the called device as a ringtone when a calling device makes a call to the called device. The method further includes sending the ringtone setup request to the called device for an acknowledgement. Upon receipt of the acknowledgement, the media is assigned to the calling device in the called device. The method further includes, when the calling device makes a call to the called device, enabling playing of the media file by the called device.

Implementations of the current subject matter can include, but are not limited to, systems and methods consistent including one or more features are described as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a diagram illustrating aspects of a system showing features consistent with implementations of the current subject matter;

FIG. 2 is a process flow diagram illustrating aspects of a system and method having one or more features consistent with implementations of the current subject matter;

FIG. 3 is a process flow diagram illustrating other aspects of a system and method having one or more features consistent with implementations of the current subject matter; and

FIG. 4 is a process flow diagram illustrating yet other aspects of a system and method having one or more features consistent with implementations of the current subject matter.

FIG. 5 illustrates a method for providing media content designated by a caller to be played by a call recipient's mobile device.

When practical, similar reference numbers denote similar structures, features, or elements.

### DETAILED DESCRIPTION

To address these and potentially other issues with currently available solutions, methods, systems, articles of manufacture, and the like consistent with one or more implementations of the current subject matter can, among other possible advantages, provide systems and methods enabling selection of media by a caller, to use the media selection as a ringtone on the call receiver's mobile device. As used herein, the term “ringtone” is any digital content that is represented by communications between mobile devices, or which is stored in a local memory and accessed by an identifier, code, address, mapping, pointer or other type of identifier. The digital content of the ringtone can include audio, video, images, voice, text, characters, or any combination thereof

This process is done through the use of a software application that will allow the user to first select a media type. For example, one could choose from music, video, photo or a sound clip as the media type. Once a media type has been selected, the next step is to either search by title in that category or to choose from a list of the top downloaded media content from that category. For example, if one chooses music as a media type and then selects country as a genre of music, a list of top country songs will be listed or the user can type in the name of a favorite country song. The third step comes after the media is selected. The media selection can then be assigned to a contact in the users contact list. It should be noted that a user's complete contact list will be downloaded into the software so that the software can facilitate the assignment of a media selection to each contact as desired. The software has two modes, censored and uncensored. The censored mode will limit any inappropriate media clips from being transmitted and received. The uncensored mode will allow any media clips to be transmitted and received. In both modes, users will be able to assign a media selection to one contact or all of its contacts in the software. In some implementations, the user assigns a different media clip as a ringtone to each one of their contacts, and has the option to change each media selection as desired in the software.

The invention goes beyond the current ring tone model in that it allows for the caller to choose a media selection as the ring tone on the call receiver's mobile devise. The current ring tone model only allows for the receiver to select the ring tone that used for incoming calls. This model shifts the paradigm and allows for a new way to express thought through a phone call.

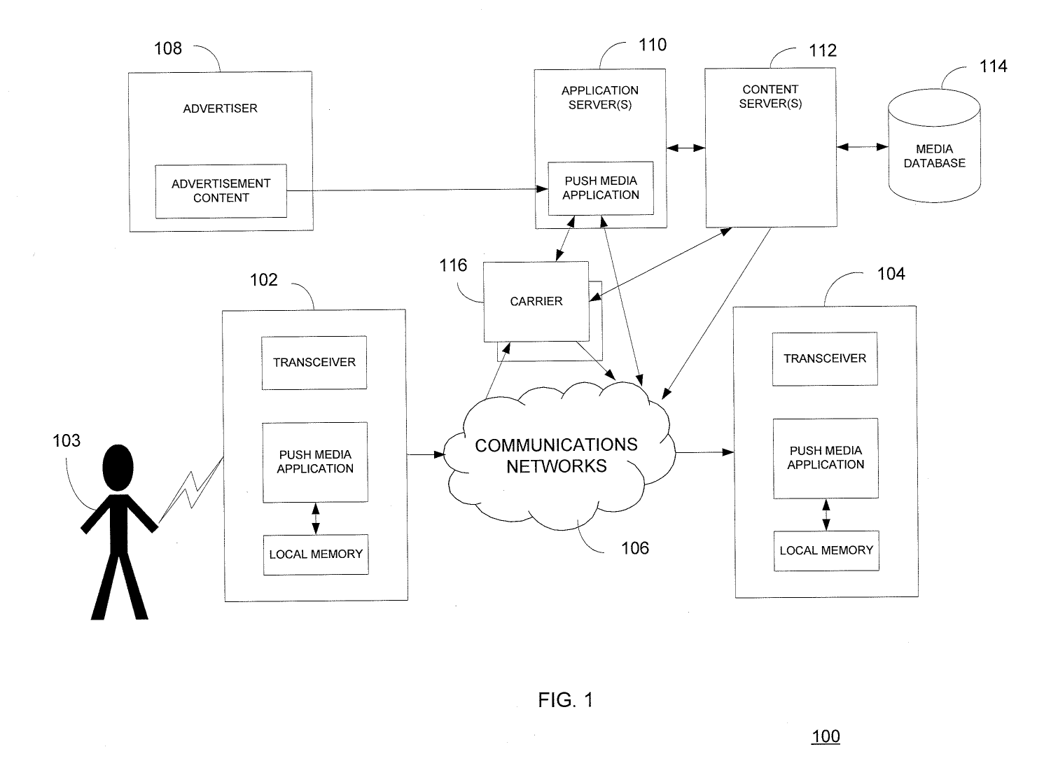

FIG. 1 is a block diagram of a system 100 for selecting media content by a caller to be played by a call recipient's mobile device. The system 100 includes a caller's mobile device 102 that is operated by a caller 103. The caller's mobile device 102 is hereafter also referred to as “the calling device” or “first mobile device” interchangeably. The caller's mobile device 102 is able to communicate with one or more recipient's mobile devices 104 (or the “called device” or “second mobile device”) via communication network 106. The caller's and/or call recipient's mobile device 102/104 can be any type of mobile communication device such as a smart phone, tablet computer, laptop, cellular phone, or network-enabled media player. The network 106 can be any number and types of communication mediums, including wireless networks and wired networks, operating under any of a number of communication protocols, frequencies and transmission schemes.

Each of the mobile devices 102/104 includes a transceiver for executing the communication functions according to one or more of a number of communication specifications or protocols, such as CDMA, GSM, WCDMA, etc. Each of the mobile devices 102/104 also includes a local memory and one or more processors for storing and executing, respectively, a push media application according to the methods described herein. Further, the local memory can store contact information, ringtone mappings, ringtone content, identifier information, etc.

The system 100 can also include one or more advertisers 108 that provide advertisement content. The advertisement content can be produced by the advertiser 108 or produced by a third party agent or content generator. The advertiser 108 can be a corporate entity, an individual, a nonprofit organization, or any other entity that can generate advertisement content. The advertisement content can be transmitted or otherwise delivered to an application server 110 that hosts a server-based push media application.

The application server 110 can be one or more server computers that deliver the local push media application software and related content to the push media applications locally on the mobile devices 102/104. Alternatively, the application server 110 can be associated with one or more content servers 112 that either provide content from a media database 114 to the application server 110, directly to the mobile devices 102/104 via network 106, or through one of a number of mobile device service carriers 116. The carrier 116 can act as a middleman to store and deliver content, perform billing and collection functions for the push media services, in addition to managing settings, connections, network services, or the like, on behalf of subscribers that can include the users of the mobile devices 102/104.

In some implementations, the ringtone is designated with a unique identifier that is sent with a call. For each call, an origination message (a very short message of less than a second in length) is sent by the calling mobile device, which includes its Mobile Identification Number (MIN, a 10-digit number derived from a mobile device's phone number), as well as the Electronic Serial Number (ESN, a unique 32-bit number programmed into the phone when it is manufactured), and the number that has been dialed. Once the cellular service provider verifies that the caller is among its customers—based on the sent-out MIN and ESN—the base station sends a channel assignment message to the cellular phone (also less than a second in length), telling the receiving mobile device where the conversation will be. Also transmitted as part of this call is a System Identification Code (SID)—a unique 5-digit number that is assigned to each carrier by the FCC.

The system and method as described above enables a number of revenue opportunities which include, but are not limited to, the following:

Advertisements. Advertisers pay to have images or any other advertisement content to be used as a ringtone or a part of the media transmission of the ringtone. For example, a soda manufacturer can pay to have their logo displayed in conjunction with a particular chosen ringtone media, such as an image, video, or music file.

Rankings Media content providers can pay to be ranked in the top downloads for the push media system and method described herein. For instance, a ringer application can have a top 100 list of music, videos, commercials and media available on the application. New music, movies or products can be promoted for listing in the top downloads of a particular media category.

Web traffic. The website can utilize traditional revenue models for users to see paid web site advertisement.

Informational content. The system and method can implement or be otherwise integrated with a broadcast announcement system for emergencies such as a storm, tornado, tsunami, earthquake or other warning, or of a national, regional or local announcement, such as traffic warnings, which can also be based on a caller's and or recipient's mobile device location. For instance, a caller can set up the system to send and precede a music ringtone with a brief traffic report if the system determines that, based on the discerned location of the recipient's mobile device, the recipient is traveling on a freeway in a vehicle.

Flash Points. The system and method can integrate flash inserts (i.e. fractions or more of a millisecond) of pictures or videos embedded in the main media being sent, as a paid subliminal message delivered to a called party.

Media IDs. The system and method can implement a caller ID with the selected pushed media. For example, when a commercial enterprise makes a call, the enterprise can push their trademarked “jingle,” logo, or other identifying media.

E-commerce. Recipients can purchase items from ads or media ringtones, or from links or other hypertext attributes provided in a pushed media ringtone. The recipient of the mobile media can also learn more about the media being sent, such as a song, and purchase it or an item with the push of a button or other action as implemented internally by the push media application. Any purchase could then be delivered to the purchaser's home or virtual storage, whether or not associated with the push media application or media database. Alternatively, the push media application can be linked to, or otherwise integrated with, a separate e-commerce application.

Personal ID. The push media application can enable a user to send their friends selected mobile media, such as a media file that the caller wants each particular recipient to receive when called. Further, friends or people who have a recipient's number, or who have the recipient's contact information in a contact database, for example, can select copyrighted and properly licensed media to be viewed or listened to by the recipient when the caller calls the recipient's mobile device.

Cross marketing. The system and method enables branding and cross-branding with companies, for example, a particular carrier 116 can have exclusive rights to particular media files in the media database 114, or have a relationship with an advertiser 108 for their advertisement content.

Reverse Marketing. In this implementation, companies pay users for the user's their media. In particular, a mobile user will receive credits to offset or subsidize their monthly bill or some form of payment for using an advertiser's advertisement content, or any other media from a media database.

In any of the above implementations, personal user information (i.e., name, address, email, preferences, dislikes, purchase trends, demographics, etc.) can be associated with the media content for cross-selling opportunities with other brands or advertisers, the carriers, or between users.

The media and software works according the following processes:

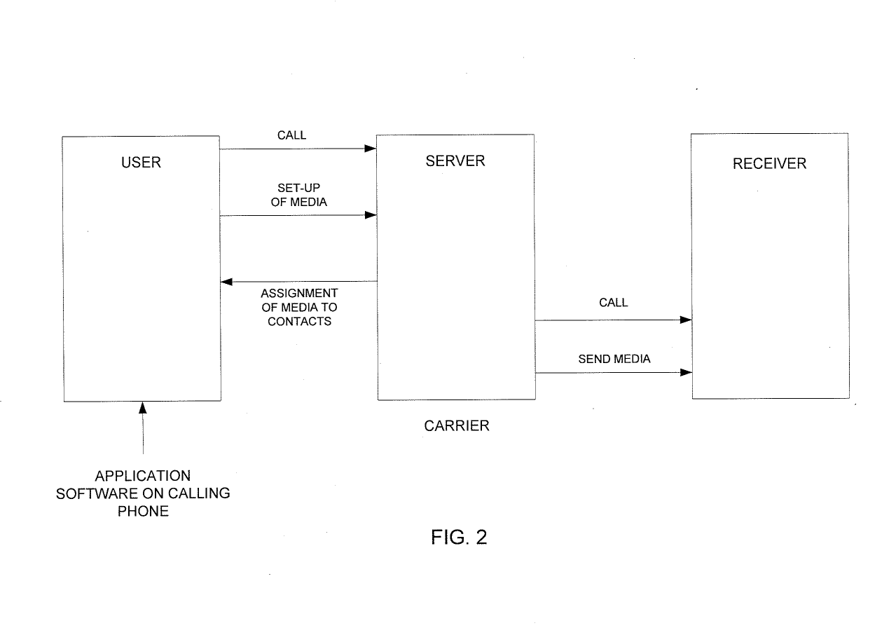

1. The software to implement the processes described above is embedded in the carrier's servers/system, either for download for being standard with all or a portion of mobile devices in a carrier's network. See FIG. 2.

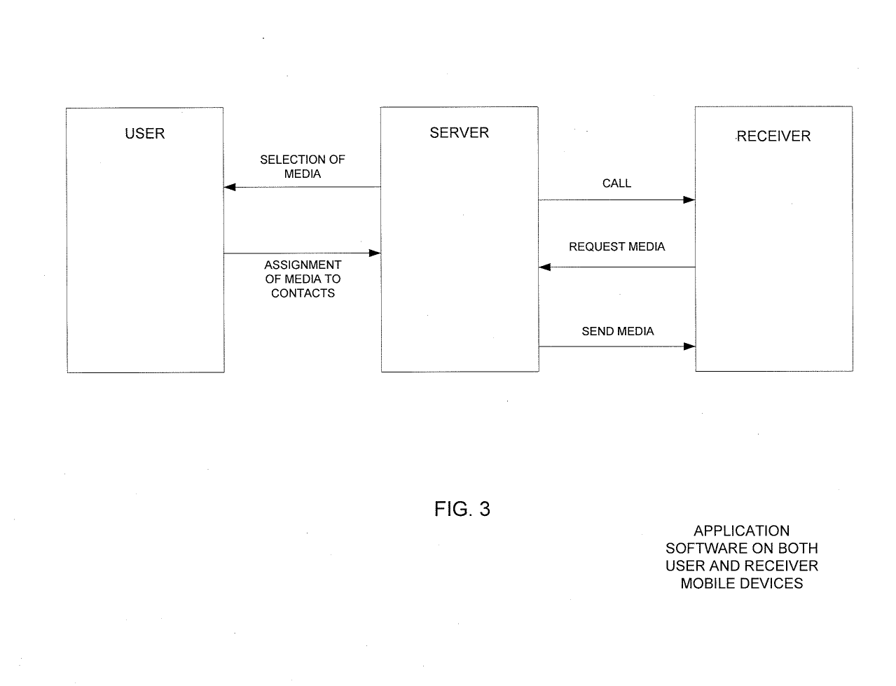

2. The software is an application that is downloaded to and/or resides on both the calling mobile device and the recipient's mobile device. See FIG. 3.

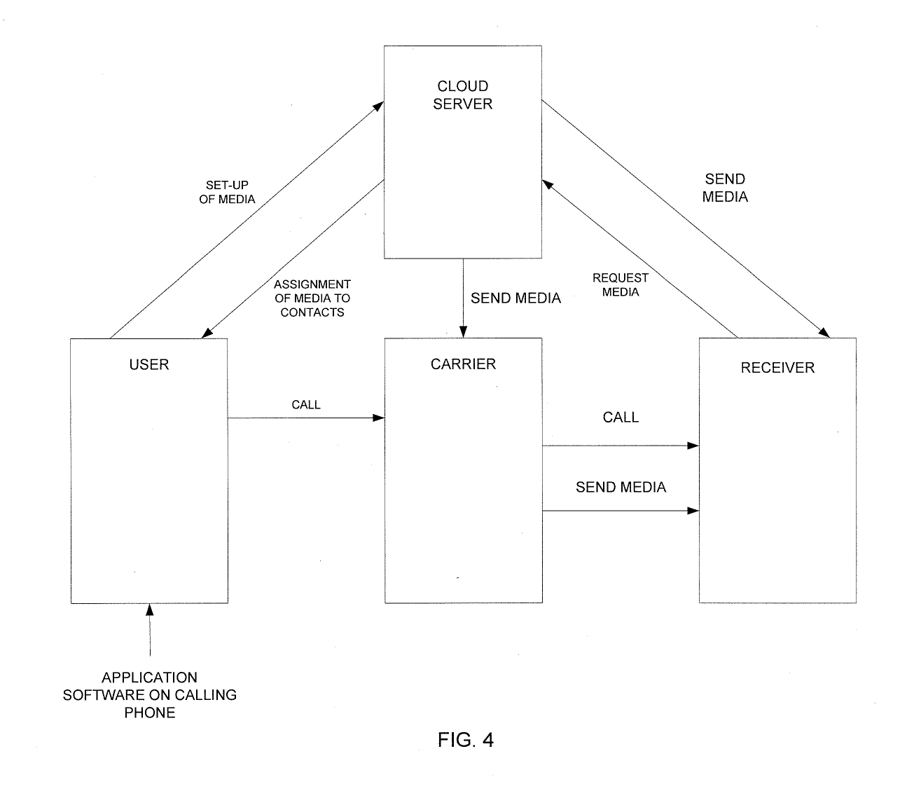

3. In some implementations, the application software does not reside on either mobile device, but on a “cloud server” and the media is delivered from the cloud from and to each mobile device related to the call, or can be delivered from a cloud server to the recipient mobile device via carrier server. See FIG. 4.

4. In yet other implementations, the software resides in a network outside of the cellular network, and which transmits the data via WIFI, internet or other form of wide area network.

In one example, a user who likes a particular song may select it as a ringtone, and assign it to a recipient, either by phone number, ESN or MIN, or other identifier. When that user calls the mobile device of the recipient, the recipient's mobile device will ring by playing the particular song. The particular song may alert the recipient of the identity to the caller, or such song or other ringtone may have some other underlying informational content or value. For example, the ringtone may be a song or other audio clip with lively or bright overtones, signaling the recipient of a positive mood of the caller. Likewise, the ringtone may be a song or other audio clip with dark or dreary overtones, signaling the recipient of a dark or angry mood of the caller.

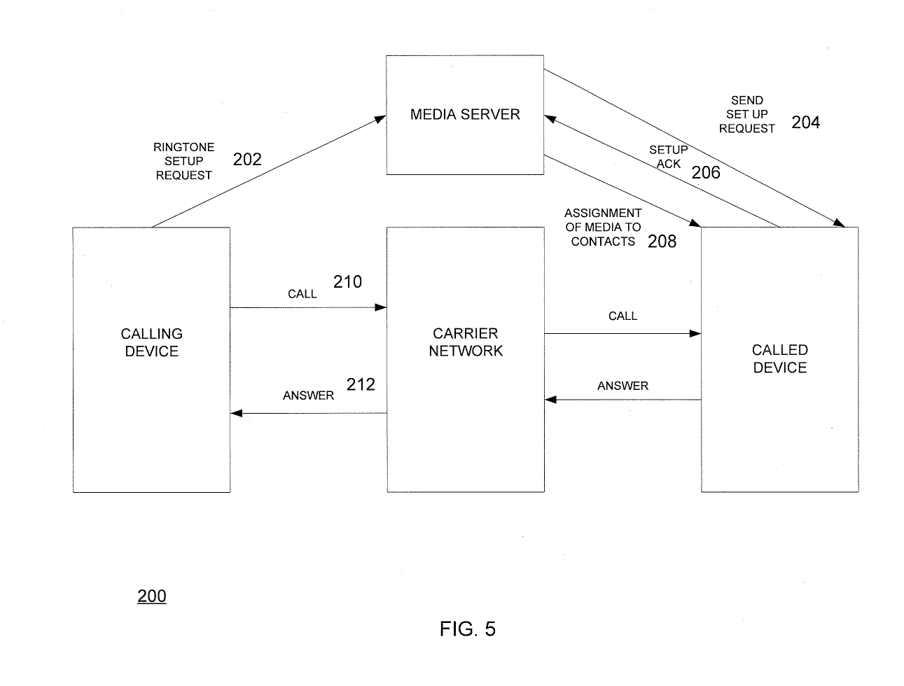

FIG. 5 illustrates a method 200 for selecting media content by a caller to be played by a call recipient's mobile device. At 202 a ringtone setup request is received by a media server, which also includes a media repository and media management software for executing media assignment, distribution, management, billing, and other functions, to name a few. The media repository can be included with the media server, or may exist as a distributed media storage platform (i.e., as a “cloud” storage service) connected by a communications network. The ringtone setup request can be received by the media server from a calling device, or from any other type of computing device, including, without limitation, a laptop computer, a desktop computer, smart phone, tablet computer, or the like. The ringtone setup request can also be received from another server, as a bridge from any calling device.

The ringtone setup request includes at least an identifier of a called device (i.e. a future recipient's mobile device). The identifier can include a phone number, but may also be represented by a name, symbol, or other alpha-numeric characters or codes. The identifier is processed by the media server to determine the called device. The ringtone setup request may also include a designator of the media to be assigned to be played when the calling device makes a call to the called device. The media can be designated as a file, object, clip or other piece of data or digital information. The designator can be selected by a user of the calling device, and sent to the media server as part of, or separate from, the ringtone setup request.

At 204, the media server sends a setup request to the called device, to inform the called device of the setup. The setup request is preferably transmitted based on the identifier. At 206, the media server receives a setup acknowledgement from the called device. The setup acknowledgement can be automatically generated by an application running on the called device, and may or may not be autonomous from the user of the called device. In other implementations, the acknowledgement is based on an explicit user input by a user of the called device. The acknowledgement at 206 enables the media server to authorize the called device to play the designated media from the media repository.

At 208, the designated media is assigned to the called device. In some implementations, the assignment can include associating the assigned media with a user of the calling device, as represented in a contacts list stored on the called device. In other implementations, the assignment can include the media server sending, streaming, downloading or otherwise transmitting the media over a communications network for storage locally on the called device.

At 210 the calling device makes a call to the called device via a carrier network, which can be one or more wireless and/or wired communication networks managed by one or more carriers. The call causes the called device to play the media designated to it and which is associated with the calling device. In some implementations, the media can be stored locally, and played locally as soon as the call is received by the called device. In other implementations, the call starts a network connection between the called device and the media server for near-real time access and downloading, and consequent playing, of the designated media. In this latter implementation, none of the media content associated with the system or method herein is stored at the called device (or the calling device, for that matter), and playing of the media content at or near after the time of a call is done on-the-fly.

Other types of media can be used. For example, a user can select a media clip of a football player throwing a famous touchdown pass, and assign or designate the media clip to one or more potential recipients. The assignment can be based on the recipient's appreciation or affinity to the content of the media clip, i.e. the recipients may be a football fan, or in particular a fan of a featured football player. When the user calls the mobile device of the recipient, the recipient's mobile device receives the call, and in response plays the media clip. In this manner, a particular media clip may be indicative or identifying of a particular caller to the recipient.

The system and method described above is substantially the same for any media content that is selected from a media database and assigned as a ringtone for one or more receivers, and enabled to be played on the mobile device of each of the one or more receivers. When a call is placed, the selected media will be the ringtone by the recipient's mobile device.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a mobile device and/or computer having a display device, such as for example a multi-touch display, a liquid crystal display (LCD) or a light emitting diode (LED) monitor for displaying information to the user. The mobile device and/or computer can also include a keyboard and/or a pointing device, such as for example a mouse or a trackball, by which the user may provide input to the mobile device and/or computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
selecting a ringtone from a set of ringtones;
designating the selected ringtone for a recipient; and
establishing a call with the recipient, the call including enabling the ringtone to be played by a mobile device associated with the recipient upon receiving the call.

2. The method in accordance with claim 1, wherein the ringtone is played according to the designation.

3. A computer program product comprising a machine-readable medium storing instructions that, when executed by at least one programmable processor, cause the at least one programmable processor to perform operations comprising:
select a ringtone from a set of ringtones;
designate the selected ringtone for a recipient; and
establish a call with the recipient, the call including enabling the ringtone to be played by a mobile device associated with the recipient upon receiving the call.

4. A method comprising:
receiving, by a mobile device associated with a recipient, a call via a communications network, the call originating from a calling mobile device that has designated a ringtone for the recipient; and
playing, by the mobile device associated with the recipient, the ringtone designated for the recipient.

5. A method comprising:
receiving a ringtone setup request by a media server, the ringtone setup request including at least an identifier of a called device and a designation of a media file to be played by the called device as a ringtone when a calling device makes a call to the called device;
sending the ringtone setup request to the called device for an acknowledgement;
upon receipt of the acknowledgement, assigning the media to the calling device in the called device; and
when the calling device makes a call to the called device, enabling playing of the media file by the called device.
